(19) United States
(12) Patent Application Publication
(10) Pub. No.: US 2026/0049646 A1
(43) Pub. Date: Feb. 19, 2026

(54) COUPLING BLOCK ELEMENT FOR A KENTER SHACKLE, FORMED FROM TWO HALF ELEMENTS WHICH CAN BE PUSHED INTO ONE ANOTHER, FOR ANCHOR CHAINS

(71) Applicant: Royal Van Beest Group B.V., Sliedrecht (NL)

(72) Inventor: Stefan MUELLER, Dortmund (DE)

(73) Assignee: Royal Van Beest Group B.V., Sliedrecht (NL)

(21) Appl. No.: 19/367,042

(22) Filed: Oct. 23, 2025

Related U.S. Application Data
(63) Continuation of application No. PCT/EP2024/061644, filed on Apr. 26, 2024.

(30) Foreign Application Priority Data
Apr. 28, 2023 (DE) 20 2023 102 314.2
Sep. 8, 2023 (DE) 10 2023 124 331.4

(51) Int. Cl. F16G 15/04

(52) U.S. Cl. CPC F16G 15/04

(57) ABSTRACT

A coupling block element for a Kenter shackle, formed from two half elements which can be pushed into one another, for anchor chains, wherein the half elements each have one short limb with a profile structure at the end and one long limb with a receiving chamber therefor. The coupling block element can be inserted between the half elements which are pushed into one another. The coupling block element has a housing which is profiled on its side surfaces, which are to face the half elements, for positively locking guidance on the half elements. At least one locking element can be displaced in a locking element guide bore and the ends of which, which exit to the outside, are configured for engaging in locking element receptacles on the inner flanks of the half elements and is arranged on each of the opposite sides of the main body.

This nonprovisional application is a continuation of International Application No. PCT/EP2024/061644, which was filed on Apr. 26, 2024, and which claims priority to German Patent Application No. 20 2023 102 314.2, which was filed in Germany on Apr. 28, 2023, and German Patent Application No. 10 2023 124 331.4, which was filed in Germany on Sep. 8, 2023, and which are both herein incorporated by reference.

### BACKGROUND OF THE INVENTION

### Field of the Invention

The invention relates to a coupling block element for a Kenter shackle, formed from two half elements which can be pushed into on another, for anchor chains.

### Description of the Background Art

A coupling block element is known from WO2017/186236A1, which corresponds to US 2019/0162270. The coupling block element inserted between the half elements is reliably locked by the two locking elements, which can be moved in opposite directions. The disadvantage is that the expansion element is secured in the housing by a thread. To assemble the coupling block element, the expansion element must first be screwed into the housing by turning it many times, which is time-consuming and energy-consuming in view of the dimensions of such Kenter shackles and the tools required for them. If the thread becomes stuck, e.g., due to the influence of sand and seawater, non-destructive dismantling of the coupling block element is no longer possible.

### SUMMARY OF THE INVENTION

It is therefore an object of the present invention to facilitate assembly and disassembly of the coupling block element and to make it less susceptible to corrosion.

The advantage is that the eccentric bolt only needs to be rotated by a maximum of 180°, and in particular only by 90°, to lock and unlock the locking elements. During locking, the base bodies of the locking elements, which are rounded on their inside, are moved away from the eccentric surfaces on the eccentric bolt and brought into contact with the cylindrical outer surface of the eccentric bolt. As a result, the locking elements are displaced towards the outside and at the same time positively locked in place. To unlock, the reverse movement takes place: the eccentric bolt is rotated, and the locking elements can move back from the outer housing to the eccentric surfaces, supported by inserted springs.

In addition, the eccentric bolt can be secured after it has been brought into the desired position. In particular, it is important to secure the locking position of the locking elements in the coupling block element in order to permanently secure the assembled shackle. The securing can be achieved, for example, by a nut that is placed on a threaded section at the end of the eccentric bolt and by means of which the eccentric bolt is axially clamped with respect to the housing of the coupling block element, so that it is secured by friction.

The central bore can be designed as a blind hole and that the eccentric bolt can be inserted into the central bore in an insertion position against the force of at least one spring element. This has the advantage that one side of the eccentric bolt no longer needs to be sealed against the housing and that the eccentric blot is not inseparably connected to its bolt element due to corrosion. Rather, the spring element in the blind hole, in particular a spring element positioned at the bottom of the blind hole, ensures that the eccentric bolt is pushed out of the blind hole if it has previously been turned into the unlocking position.

Two parallel eccentric surfaces can be provided on the eccentric bolt, which are arranged at the same distance from the axis of rotation. As a result, the two locking elements are moved at the same time and, if they are the same length, they enter their receptacles on the half elements of the Kenter shackle at the same time.

Alternatively, the eccentric surfaces can be tilted against one another or arranged concave or convex. This makes it possible to achieve simple sequence control of the movement of the locking elements. With the same rotation of the eccentric bolt, it is achieved that one locking element is extended earlier and reaches its receptacle earlier than the other. This can be advantageous, as one locking element is then already aligned with the shackle by engaging in its corresponding recess, while the other is still moving towards its receptacle. If the locking elements have become stuck in their bores due to corrosion or the like, this design is also advantageous, since the entire torque applied to the eccentric bolt acts successively on only one locking element, and the forces caused by this are not divided between two locking elements.

A complete Kenter shackle for anchor chains is obtained by inserting a coupling block element according to the invention between two half elements which can be pushed into one another, each with one short limb with a profile structure at the end and one long limb with a receiving chamber therefor. Such a Kenter shackle has the same curves on both sides and can therefore pass through an anchor winch like a chain link.

The coupling block element of the invention can also be part of an anchor Kenter shackle, which also comprises two half elements which can be pushed into one another, each with one short limb with a profile structure at the end and one long limb with a receiving chamber therefor. An anchor Kenter shackle has different curves on both sides. One side forms the end of a chain and is therefore adapted to the curves of the chain links. The other side, which is used to connect to an anchor, is less curved and slightly pointed, and has a smaller eye.

The coupling block element can be inserted at right angles to the direction of the joints between the half elements, so that they can no longer detach from one another.

The coupling block element can be positively connected to the half elements via the locking elements. Also, it is advantageous to additionally profile the two opposing inner flanks of the half elements, between which the coupling block element is inserted, and the adjacent outer sides of the coupling block element in order to achieve a positive guidance.

For this purpose, it may be provided, for example, that elevated surfaces are formed on protrusions on the inner flanks and complementary recesses are formed on the coupling block element. As a result, the coupling block element is positively guided along edges of the protrusions and, in its intended end position between the limbs, blocks any relative movement between the two half elements.

In order to counteract the penetration of sand, salt water or organisms such as barnacles and to prevent the eccentric bolt from getting stuck due to the impact of such factors, it is provided in particular that both the eccentric bolt and the locking elements are each sealed from the housing by at least one sealing ring.

The central bore in the housing can be a blind hole and the eccentric bolt may be correspondingly short. This means that there may be only one large opening on the housing for the eccentric bolt. In addition, there is no need for the axial fixing of the eccentric bolt by a nut or the like attached to the end, which must be provided on the outside of the housing and is correspondingly susceptible to corrosion.

In order to fix the eccentric bolt axially, it can be preloaded by at least one spring element acting between the eccentric bolt and the housing, preferably in such a way that it tends to be pushed out of the housing. At the same time, this example provides at least one bolt element protruding radially from the eccentric bolt, which engages in a bolt guide gate formed at the edge of the central bore of the housing. For the rotational movements necessary for locking and unlocking, the bolt element is guided in an arc-shaped groove of the bolt guide gate, wherein the eccentric bolt is at the same time axially fixed.

The axial preload can be used by means of at least one spring to axially advance the bolt element out of the groove in the end positions provided for locking and unlocking, so that the bolt element engages in a pocket connected to the groove in each of these positions. For the next movement, the eccentric bolt must first be moved axially into the housing against the force of the spring before it can be rotated again.

For the insertion of the eccentric bolt designed in this way, a bolt insertion opening can be provided, which extends axially from the front side of the housing, where the head of the eccentric bolt can be positioned, into the interior of the housing, where it ends in the arc-shaped groove of the bolt guide gate.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a disassembled Kenter shackle according to an example in a perspective view;

FIG. 2 shows a coupling block element in a perspective exploded view;

FIG. 3 shows the coupling block element from above;

FIG. 4 shows the coupling block element from the front;

FIG. 5 shows the locking position of the coupling block element in a perspective view;

FIG. 6 shows the head of the eccentric bolt from FIG. 5 in an enlarged detailed view;

FIG. 7 shows the coupling block element in the unlocking position in a perspective view;

FIG. 8 shows the unlocking position in a sectional view;

FIG. 9 shows the locking position in a sectional view;

FIG. 10 shows a mounted Kenter shackle with the coupling block element in longitudinal section;

FIG. 11 shows a locking system of an example of a coupling block element, in perspective view;

FIG. 12 shows the locking system according to FIG. 11 in cross-section;

FIG. 13 shows a perspective longitudinal section through the example of the coupling block element in the unlocking position;

FIG. 14 shows a perspective longitudinal section through the example of the coupling block element in the locking position;

FIG. 15 shows the coupling block element according to FIG. 14 in a perspective view from the outside;

FIG. 16 shows the coupling block element according to FIGS. 14 and 15 in a partially cut perspective view;

FIG. 17 shows a longitudinal section through the coupling block element in the locking position and

FIG. 18 shows a cross-section of the coupling block element in the locking position.

### DETAILED DESCRIPTION

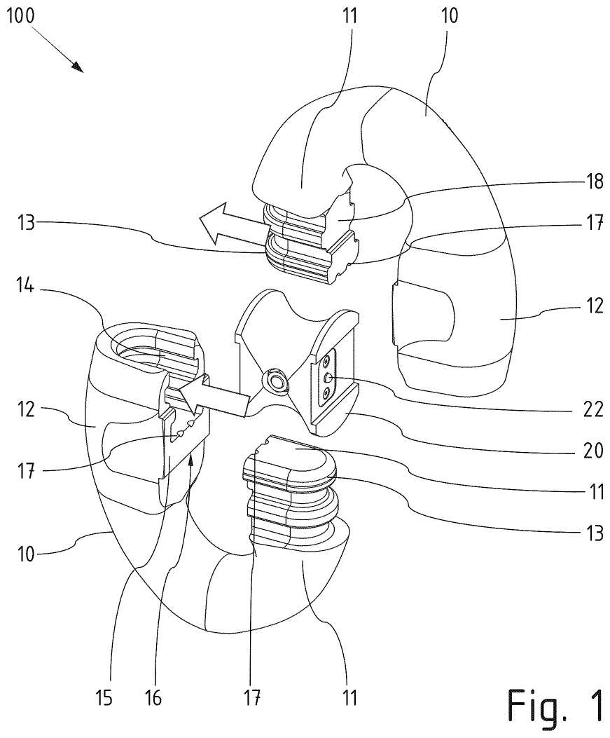

FIG. 1 shows a disassembled Kenter shackle 100 in a perspective view, which is formed of two half elements 10 which can be pushed into one another, and a coupling block element 20.

The half elements 10 have the shape of a “J” in the side view. Each half element 10 has one short limb 11, at the end of which a profile structure 13 with bulge-like protrusions and recesses in between is formed, and one long limb 12 extending to below the profile structure 13 of the short limb 11. As the illustration of a half element 10 on the left edge of the picture shows, a receiving chamber 14 for the profile structure 13 of the other, short limb 11 is incorporated into the long limb 12. The convex profile structure 13 on the outside of the short limb 11 and a complementary, concave profile structure on the inside of the receiving chamber 14 of the long limb 12 are designed in such a way that the short limb 11 can be inserted into the receiving chamber 14 from the side. The insertion direction is indicated in FIG. 1 by the block arrows. The half elements 10 pushed into one another create a closed shackle body with an oval basic shape.

The limbs 11, 12 are not completely flat on their inner flanks 18 but have a slightly raised surface 15 there. The surfaces 15 on the opposite limbs 11, 12 are plane-parallel.

In order to prevent the two half elements 10 pushed into one another from detaching from one another again, a coupling block element 20 is inserted between them. This is inserted at right angles to the direction indicated by the block arrows between the half elements 10 and is positively guided at edges 16 of the protrusions 15.

To ensure that the coupling block element 20 is secured in the end position, locking elements with a hemispherical end 22.1 are pushed out of a housing of the coupling block element 20. The ends 22.1 engage in locking element receptacles 17 on the inner surfaces of the half elements 10. This secures the coupling block element 20 against displacement and also positively fixes it between the half elements 10 in the third dimension.

In the example, the locking element receptacles 17 are divided in half since they are formed in the edge area at the transition between the protrusion 15 and the receiving chamber 14 on the long limb 12 or at the transition between the protrusion 15 and the profile structure 13 on the short limb 11.

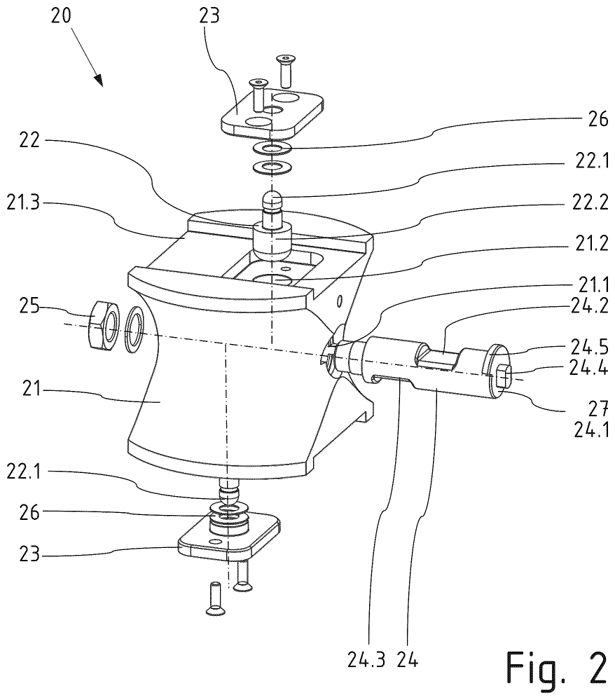

FIG. 2 shows the coupling block element 20 in a perspective exploded view.

In two locking element guide bores 21.2 of the housing 21, a locking element 22 is inserted in each case, whose hemispherical protrusion 22.1 points to the outside. Cover discs 23 are connected to the housing 21, through whose central bore the protrusion 22.1 can be pushed out and in which a larger-diameter base body 22.2 of the locking element 22 is held in place by a positive fit.

In order to push the protrusions 20.1 to the outside beyond the cover discs 23, an eccentric bolt 24 is inserted in a central bore 21.1 running transversely to the axis of the locking elements 20 and the locking element guide bores 21.2. The eccentric bolt 24 has two parallel contact surfaces 24.2, 24.3 in a middle length section, recessed and flattened with respect to the outer circumference, to which the locking elements 22 attach when the protrusions 22.1 are retracted. Springs 26, here designed as disc springs, are provided to push the bolt elements 22 away from the cover disc 23 and to keep them in contact with the contact surfaces 24.2, 24.3 on the eccentric bolt 24. The base bodies 22.2 of the locking elements 22 are rounded in a spherical shape on their side facing the eccentric bolt 24 and the edges between the cylindrical jacket of the eccentric bolt 24 and the contact surfaces 24.2, 24.3 are beveled or also rounded so that the locking elements 22 do not get caught in the area of the edges when the eccentric bolt 24 rotates.

The eccentric bolt 24 has a head 24.1 with a protrusion 24.4, to which, for example, a wrench can be applied, and an overhanging collar as a bolt element 29, which extends over less than 180° of the circumference. On the other side of the housing 21, the eccentric bolt 24 is secured with a nut 25.

The housing 21 has a recess 21.3 on each of the opposite sides where the locking elements 22 exit, which is bordered on two sides by parallel edges and is openly accessible on two other opposite sides, so that at these points it is possible to insert the coupling block element 20 onto the protrusions 15 on the half elements 15.

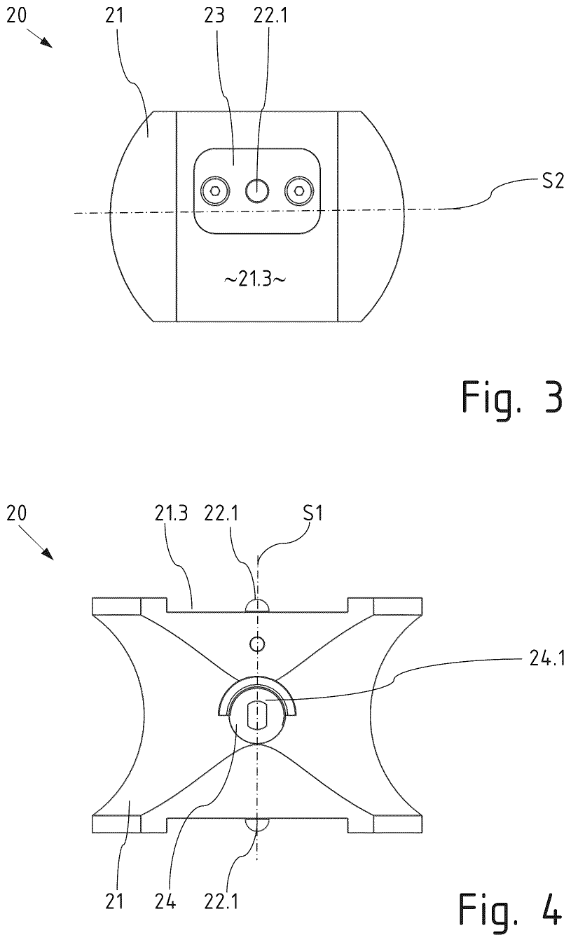

FIG. 3 shows the coupling block element 20 from the top. The recess 21.3 is used to accommodate the protrusions 15 on the half elements. The cover disc 23 is screwed to the housing 21 via several screws. The protrusion 22.1 of the locking element can protrude to the outside through a hole in it. The locking elements and cover discs 23 are each arranged with an offset to a symmetry axis S2 of the housing 21.

FIG. 4 shows the coupling block element 20 in a view from the front. Both protrusions 22.1 are moved to the outside and protrude beyond the surface of the recess 21.3. In this view, the heads 22.1 of the locking elements are arranged on a symmetry axis S1 of the housing 21. The head 24.1 of the eccentric element 24 is recessed in a receptacle 27 in the housing 21.

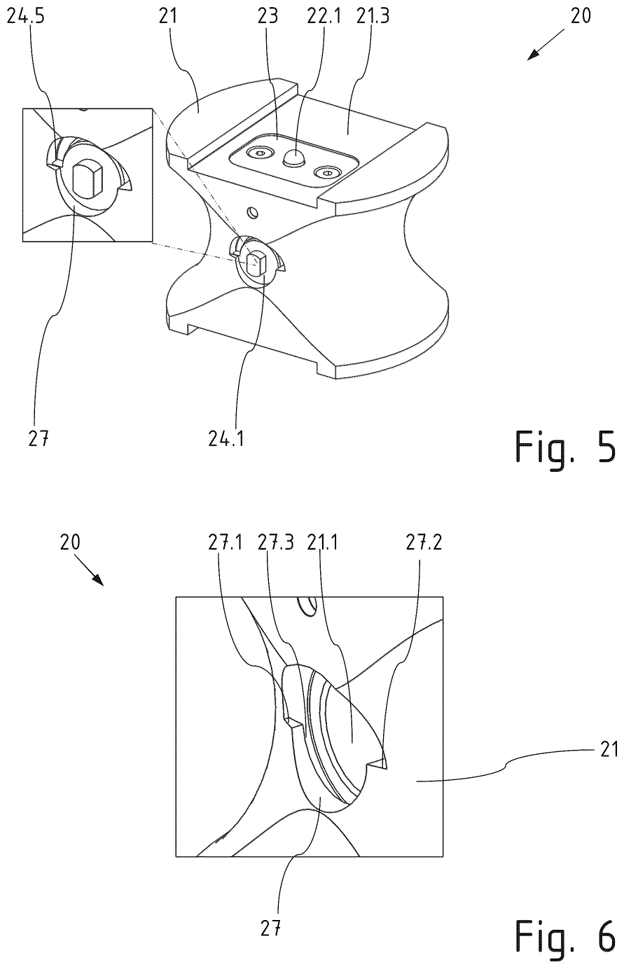

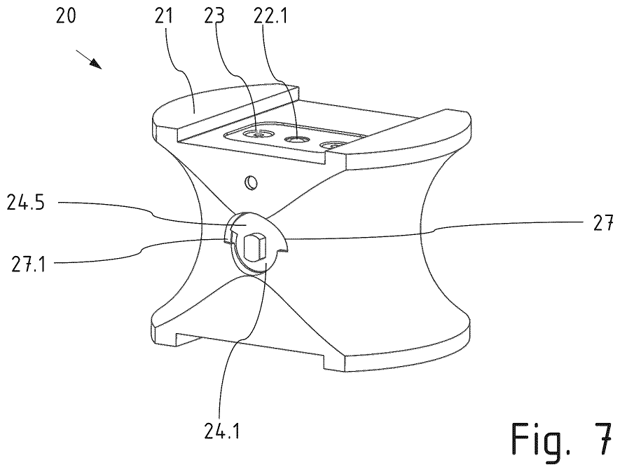

FIGS. 5 and 7 each show the coupling block element 20 in a perspective view.

FIG. 5 shows the locking position in which the hemispherical protrusions 22.1 of the locking elements are extended and protrude from the cover disc 23. On the left is an enlargement of a receptacle 27 in the housing 21 for the head 24.1 of the eccentric bolt. The bolt element 29 on the head 24.1 is placed in a concealed groove in the receptacle 27.

FIG. 6 shows receptacle 27 in the housing 21 in an enlarged detail. The receptacle 27 is formed between the mouth of the central bore 21.1 and the outside of the housing 21. The upper part of the receptacle 27 is wider than the lower one, so that the bolt element 29 (see FIG. 5) of the eccentric bolt can only be inserted at the top. The lower part is bordered by two stop edges 27.1, 27.2. Starting from the stop edge 27.1, an arc-shaped groove 27.3 extends along the inner circumference of the receptacle 27. However, the groove 27.3 does not quite reach under the stop edge 27.2.

This shaping of the groove 27.3 and the design of the bolt element at the head of the eccentric bolt ensures that the eccentric bolt can be held positively in place in the receptacle. The eccentric bolt is not only axially secured when its bolt element engages in the groove 27.3 but is also limited in rotation. This is advantageous in order to be able to mount a nut on the other side of the housing 21 for additional securing on the eccentric bolt, even in unfavorable mounting situations, without having to hold the head against the eccentric bolt.

FIG. 7 shows the coupling block element 20 in the unlocking position in another perspective view. The heads 22.1 of the locking elements are retracted into the housing 21. The bolt element 29 is located in the exposed part of the receptacle 27.

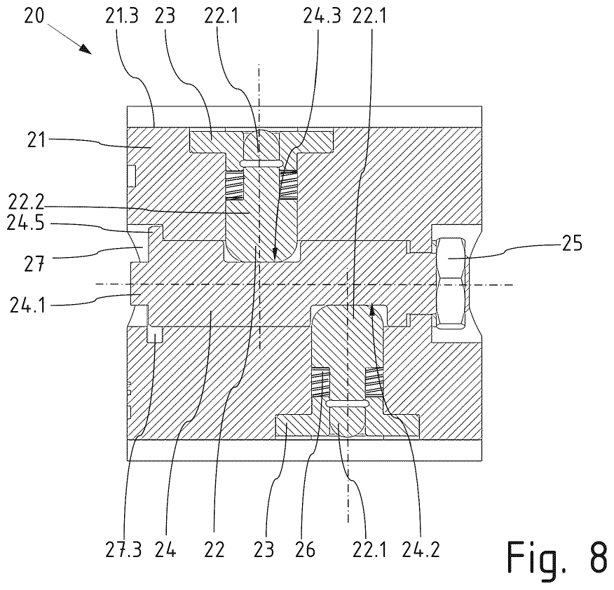

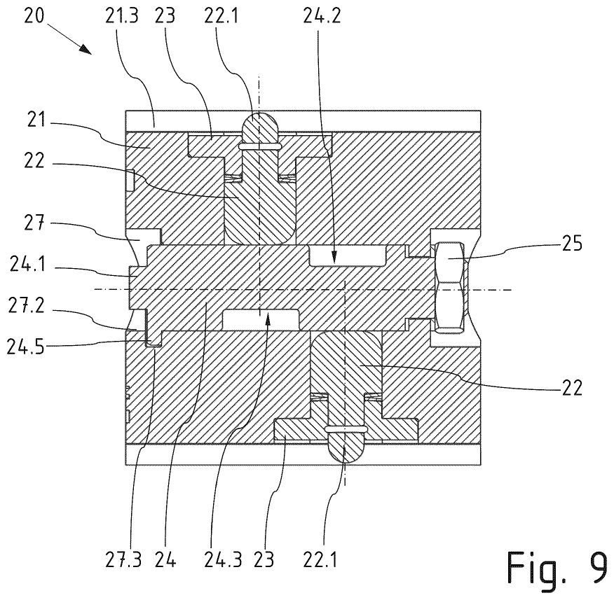

The function of the coupling block element 20 according to the invention is explained on the basis of the sectional representations in FIGS. 8 and 9.

FIG. 8 shows the unlocking position. A spring 26 is arranged between the cover disc 23 and a base body 22.2 of the locking element 22, which spring is designed as a compression spring, in particular as a disc spring. The eccentric bolt 24 is rotated in such a way that the locking elements 22 can engage in the free spaces at the contact surfaces 24.2, 24.3 due to the force of the springs 26. As a result, the hemispherical protrusion 22.1 retracts to below the surface of the recess 21.3 on the housing 21. The coupling block element 20 can be inserted in this position as soon as the half elements 10 of the Kenter shackle 100 are assembled. The bolt element 29 of the head 24.1 lies outside the groove 27.3 in the receptacle 27. However, the eccentric bolt 24 is axially secured by the fact that the base bodies 22.2 are indented into the recesses at the contact surfaces 24.2, 24.3.

In order to be able to turn the eccentric bolt 24, the nut 25 must first be loosened slightly. After inserting the coupling block element 20 into its final position between the half elements of the Kenter shackle, the eccentric bolt 24 is rotated by at least 90° but less than 180°, causing the locking elements 22 to be displaced in their bores and the protrusions 22.1 to protrude to the outside, so that they engage in assigned receptacles on the inner flanks of the half elements 10. This locking position is shown in FIG. 9. The bolt element 29 of the head 24.1 engages in the groove 27.3 in the receptacle 27. Although in this position the base bodies 22.2 of the locking elements 22 are in contact with the cylindrical part of the outer shell of the eccentric bolt 24, and there is no longer a positive fit in between, the eccentric bolt 24 is axially secured by the engagement of the bolt element 29 in the groove 27.3. The nut 25 is tightened again to prevent unintentional rotation of the eccentric bolt 24.

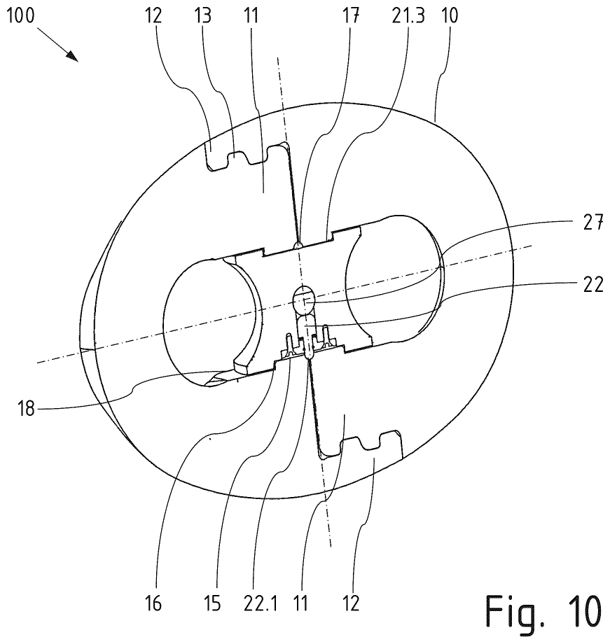

FIG. 10 shows a fully assembled Kenter shackle 100 in section, with the cutting plane parallel to the longitudinal axis, but offset to the outside, in order to intersect one of the two locking elements 22 in the coupling block element 20.

The two half elements 10 positively interlock in that the profile structures 13 on the respective short limbs 11 engage in the receiving chambers 14 on the long limbs 12. The two inner flanks 18 pointing towards one another on the shackle body formed from the joined half elements 10 merge at the edges 16 into the raised surface 15, which are formed by the two half elements 11 together. Exactly at the dividing plane between the half elements 10, a locking element receptacle 17 is formed.

Between the inner flanks 18, the coupling block element 20 is inserted. In the longitudinal direction, it is positively fixed by the edges 16. Transversely to this, it is secured by the engagement of the protrusions 22.1 in the locking element receptacles 17.

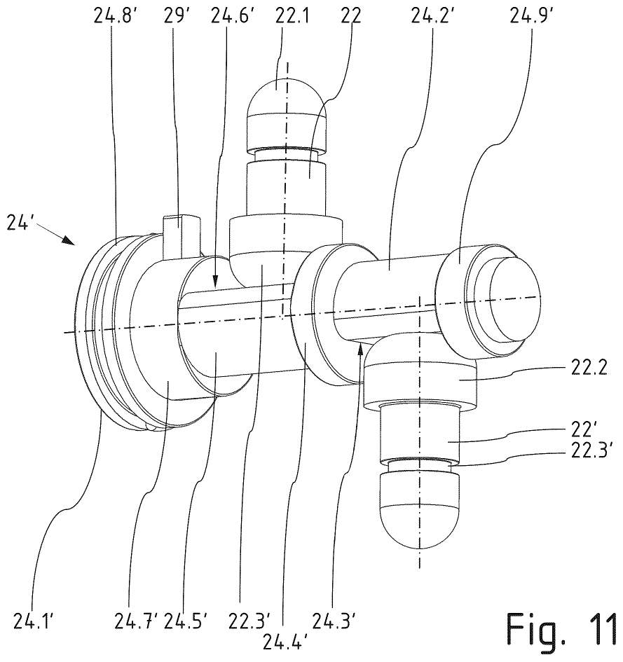

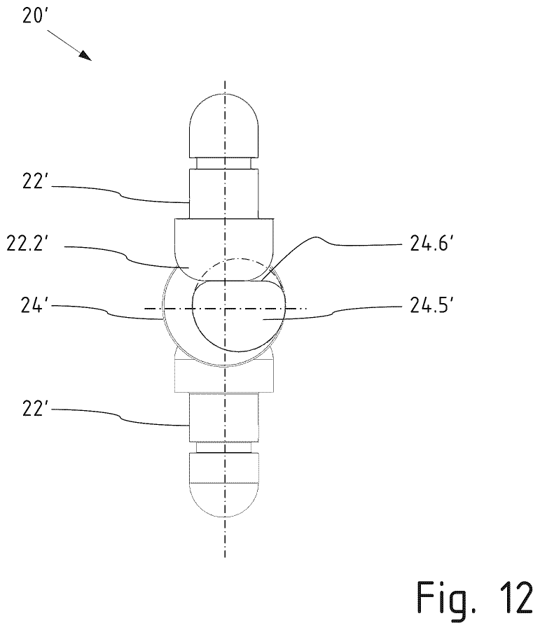

FIG. 11 shows a locking system as part of an example of a coupling block element, which can be inserted in exactly the same way as previously described with reference to FIG. 10 between two half elements 11 to form a Kenter shackle. The locking system also includes an eccentric bolt 24′ and two locking elements 22′.

The eccentric bolt 24′ has a head 24.1′ with an extended diameter and two eccentric bolt sections 24.2′, 24.5′, over which the two locking elements 22′ can be moved axially. A difference from the first example is that the head 24.1′ has at least one groove 24.8′ on the outer circumference to accommodate at least one sealing ring and is shorter overall. It has an end section 24.9′ at an end opposite the head 24.1′, which is provided for the positioning of a frontal spring element. The end section 24.9′ is designed to be short so that the entire eccentric bolt 24′ can be accommodated in a blind hole of a housing.

The eccentric bolt sections 24.2′, 24.5′ are strongly rounded before merging into contact surfaces 24.3′, 24.6′ where the rounded end areas of the locking elements 22′ are supported when the coupling block element unlocking position is set.

Further sections 24.4′, 24.7′ together with the end section 24.9′ serve to support the eccentric bolt 24′ in the housing. In section 24.7′ behind the head 24.1′, a bolt element 29′ is molded or attached. This engages with a bolt guide gate in the housing in order to limit the rotation angle of the eccentric bolt 24′ and/or to positively fix the eccentric bolt in the provided end positions.

The locking elements 22′ each have protrusions 22.1′, each with a groove 22.3′ to accommodate a sealing ring, and an end section 22.2′ with a diameter greater than the diameter of the protrusions 22.1′.

FIG. 12 shows a cross-section of the locking system shown earlier in FIG. 11. This makes it particularly clear how the position of the eccentric bolt sections 24.5′ is in relation to the rotation axis of the eccentric bolt 24′ and how their cross-sectional shape, which deviates from the circular shape indicated by the dashed line, was shaped. It can also be seen that the spherical ends of the locking elements 22′ are flattened in the center. In the unlocking position shown in FIG. 12, in which the locking elements 22′ are completely inside the housing, the locking elements 22′ each rest with the flattened area on the flat contact surface 24.6′.

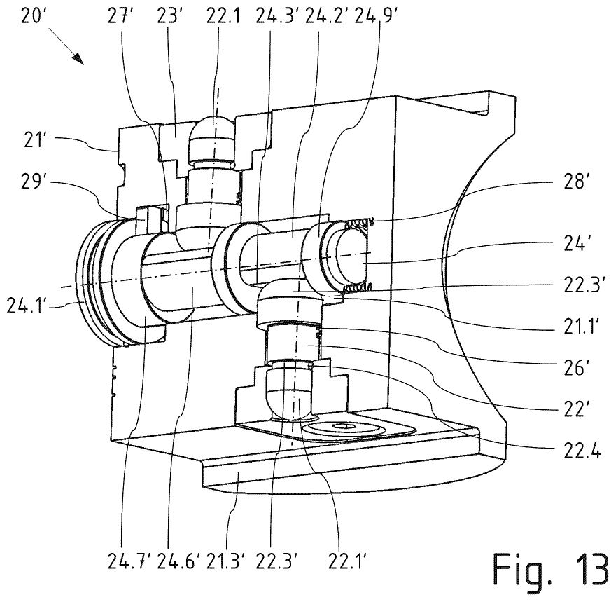

FIG. 13 shows a longitudinal section through the housing 21′ of the coupling block element 20′ in the unlocking position. A spring 26′ is attached to each section of the locking elements 22′, with which the locking element 22′ pushes off from the cover disc 23′ and keeps contact with the respective eccentric bolt section 24.2′, 24.5′. A sealing ring 22.4′ is inserted into each groove 22.3′.

A central bore 21.1′ in the housing 21′ ends in a section designed as a blind hole. The end section 24.9′ of the eccentric bolt 24′ is mounted there and supported by a spring 28′ or a pack of springs on the housing 21′. On the one hand, this makes it possible to align the head 24.1′ flush with the outside of the housing 21′. On the other hand, a continuous pre-tensioning of the eccentric bolt 24′ in the direction of the opening of the central bore 21.1′ is specified.

The possible movements of the eccentric bolt 24′ in relation to the housing 21′ are defined in a form-fitting manner in the example shown, in that the eccentric bolt 24′ is guided via its bolt element 29′ and a bolt guide gate 27′ formed in the housing 21′.

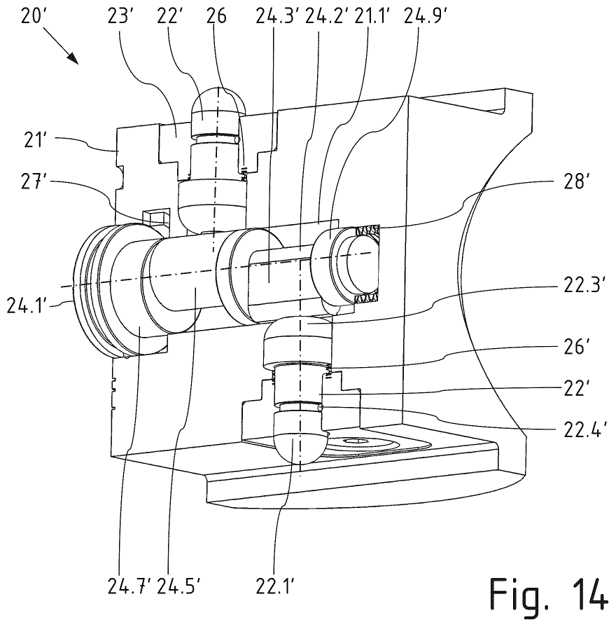

FIG. 14 shows a representation analogous to FIG. 13, with the difference that the eccentric bolt 24′ has been rotated by about 90° so that the locking elements 22′ have been pushed to the outside via the eccentric bolt sections 24.2′, 24.5′ and are now in the locking position and protrude with their heads over the cover plates 23′.

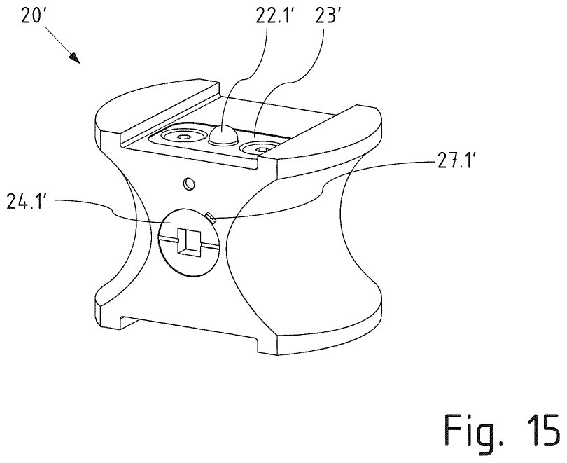

In the perspective view of the coupling block element 20′ in the locking position in FIG. 15, it can be seen that, on the one hand, the eccentric bolt with its head 24.1′ is flush with the side surface of the housing 21′ and, on the other hand, that a bolt insertion opening 27.1′ is provided in order to be able to guide the bolt element 29′ recognizable in FIG. 13 from the front of the housing 21′ into the internal bolt holder. The bolt insertion opening 27.1′ is sealed watertight after the eccentric bolt 24′ has been inserted into the housing 21′. This can be done by means of a rubber stopper and/or a fat filling.

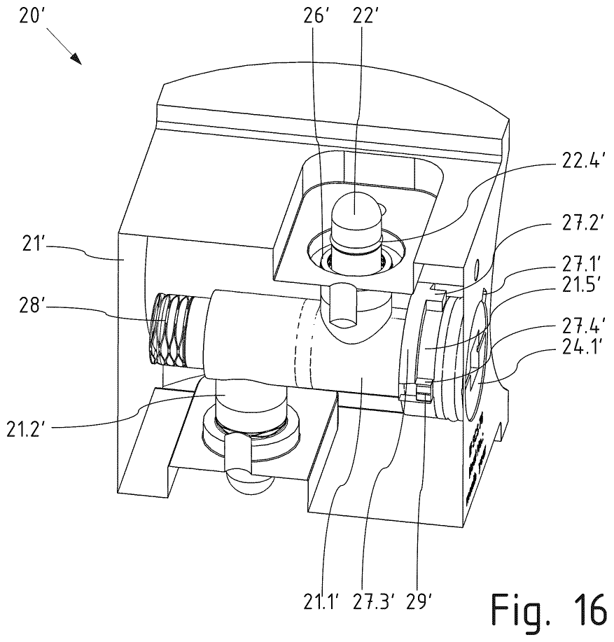

FIG. 16 shows a representation in which the housing 21′ is cut but shown as a transparent body, so that the contour of the central bore 21.1′ becomes visible and the axial locking of the eccentric bolt 24′ can be represented in relation to the housing 21′. The locking element guide holes 21.2′ are also clearly visible.

In FIG. 16, the eccentric bolt 24′ is already inserted into the central bore 21.1′. The central bore 21.1′ has an initial section 21.5′ extended in diameter, in which the head 24.1′ of the eccentric bolt 24′ is received. This initial section 21.5′ is extended over part of its circumference by a circular or arc-shaped groove 27.3′. The bolt insertion opening 27.1′ opens in the groove 27.3′, through which the bolt element 29′ is inserted when the eccentric bolt 24′ is inserted into the housing 21′. From the groove 27.3′, two short pockets 27.2′, 27.3′ extend towards the front of the housing 21′, but end well in front of it. Their axial extension is only so large that the bolt element 29′ of the eccentric bolt 24′ can be moved straight out of the groove 27.3′ and into one of the pockets 27.2′, 27.3′.

The illustration in FIG. 16 also shows that the eccentric bolt 24′ with its bolt element 29′ can be inserted into the housing 21′ via the bolt insertion opening 27.1′. To do this, the cover discs must first be removed from the housing 21′ so that the springs 26′ on the locking elements 22′ are destressed and the locking elements 22′ can be moved to the outside. Even before the eccentric bolt is inserted, the spring 28′ has been placed on its end section, through which the eccentric bolt is constantly pushed from the central bore 21.1′, which is designed as a blind hole, towards the opening of the central bore 21.1′.

In order to be able to insert the eccentric bolt into the housing, it must be inserted into the housing against the force of the spring 28′ and is then slightly twisted, wherein the locking element gets caught in the groove 27.3′ and from then on axially secures the eccentric bolt during further movement. After inserting the eccentric bolt into the housing, the locking elements 22′ can again engage in the eccentric bolt sections 24.2′, 24.5′ (see FIG. 13). They are pre-tensioned by putting the cover discs 23 (see FIG. 15) back on and screwing them together. This means that the eccentric bolt is also secured by the locking elements 22′ and can no longer get out of the housing, even if the locking element 29′ were moved to the position in front of the bolt insertion opening 27.1′.

In normal use, the eccentric bolt is only moved back and forth between the end positions defined by the pockets 27.2′, 27.4′ for the unlocking and locking positions. To do this, the eccentric bolt must be moved axially into the interior of the housing against the force of the spring 28′ in order to disengage the locking element 29′ from the respective pocket 27.1′, 27.4′ and bring it into the groove 27.3′. Then, a rotation of about a quarter circle can be performed. Finally, due to the preload caused by the spring 28′, the bolt element 29′ moves into the other pocket 27.1′, 27.4′.

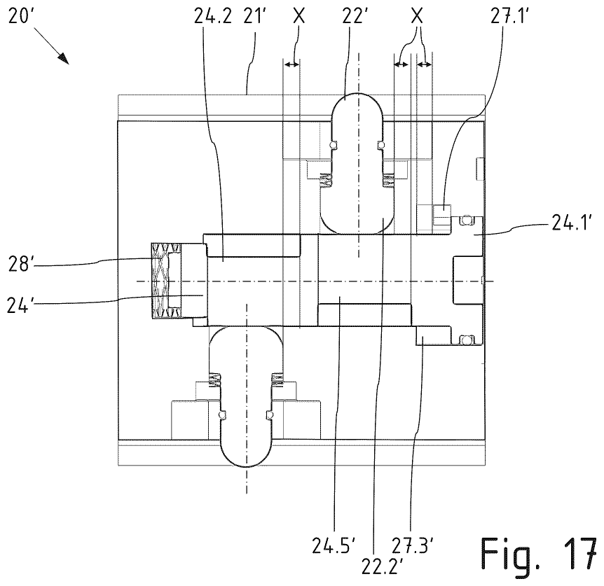

From the longitudinal section through the coupling block element 20′ in FIG. 17 it is clear that the diameter of the end sections 22.2′ of the locking elements 22′ in relation to the axial length of the eccentric bolt sections 24.2′, 24.5′ is each dimensioned in such a way that there is still an axial displacement travel X after the eccentric bolt 24′ has been inserted into the housing and the locking elements 22′ engage in the eccentric bolt sections 24.2′, 24.5′. Due to this displacement path X, it is possible in each case that the bolt element 29′ can be moved out of the pocket 27.1 2′ into the groove 27.3′, so that the twisting of the eccentric bolt 24′ by about 90° into the other end position is possible.

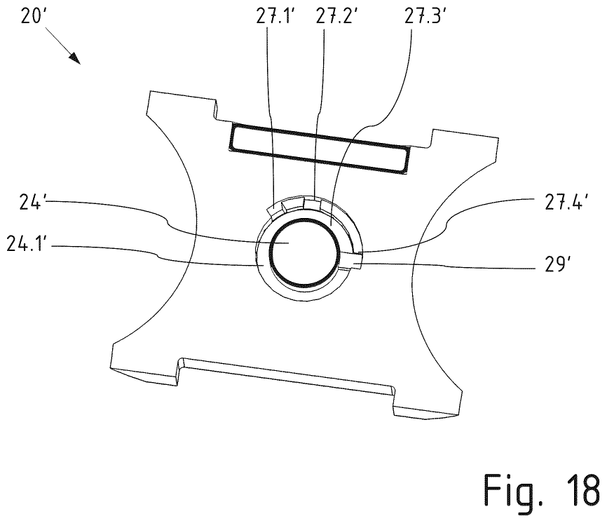

FIG. 18 is a perspective cross-section of the coupling block element 20′. The front side of the housing 21′, which has the opening for the head 24.1′ of the eccentric bolt 24′, is concealed at the back in this view. The cutting plane runs through the bolt guide gate 27′ for the bolt element 29′, wherein the bolt guide gate 27′ comprises:
The bolt insertion opening 27.1
two pockets 27.2′, 27.4′ and
the groove 27.3′

As can be seen from this diagram, the groove 27.3′ must extend as a circular arc at least between the bolt insertion opening 27.1 and the pocket 27.4′.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A coupling block element for a Kenter shackle, formed from two half elements which can be pushed onto one another, for anchor chains, wherein the half elements each have one short limb with a profile structure at an end and one long limb with a receiving chamber, the coupling block element being adapted to be inserted between the half elements that are pushed onto one another, the coupling block element comprising:
a housing that is profiled on its side surfaces, which are to face the half elements, for positive locking guidance on the half elements; and
at least one locking element adapted to be displaced in a locking element guide bore, and the ends of which, which exit to an outside, are configured for engaging in locking element receptacles on the inner flanks of the half elements and is arranged on each of the opposite sides of the housing,
wherein the at least one locking element is adapted to be displaced to the outside via a common expansion element which engages between locking elements,
wherein the expansion element is formed by an eccentric bolt, which is arranged rotatably in a central bore oriented at a right angle with respect to the locking element guide bore of the locking element in the housing, and which has a non-round cross-section at least in a region which adjoins the locking element guide bore of the locking element.

2. The coupling block element according to claim 1, wherein the non-round cross-sectional region has at least one flat contact surface for attachment of the locking element in an opening position and/or in a closing position of the locking element.

3. The coupling block element according to claim 1, wherein the eccentric bolt has a head with a non-round circumference, which is secured against twisting in a compatible, recessed receptacle in a side surface of the housing.

4. The coupling block element according to claim 1, wherein the central axis of the eccentric bolt, the locking element guide bores and the locking elements are arranged on a first symmetry axis of the housing.

5. The coupling block element according to claim 1, wherein the locking element guide holes and the locking elements end vertically in the central bore of the eccentric bolt and are arranged axially to one another and offset to a second axis of symmetry.

6. The coupling block element according to claim 1, wherein on the housing at the mouth of the central bore, a recessed receptacle for the head of the eccentric bolt is formed.

7. The coupling block element according to claim 6, wherein at the head of the eccentric bolt, a bolt element is arranged radially protruding over a section on the eccentric bolt, which engages with a bolt guide gate at the receptacle for the head.

8. The coupling block element according to claim 1, wherein the eccentric bolt is axially secured in the central bore via the engagement of the bolt element in the groove and/or via the locking elements indented in the recesses on the eccentric bolt at the contact surfaces.

9. The coupling block element according to claim 1, wherein the central bore is configured as a blind hole and that the eccentric bolt is adapted to be inserted into the central bore against the force of at least one spring member.

10. A Kenter shackle or anchor Kenter shackle for anchor chains, comprising:
two half elements adapted to be pushed onto one another, each with one short limb with a profile structure at an end and one long limb with a receiving chamber therefor, the locking element receptacles being formed on inner flanks of the half elements; and
the coupling block element according to claim 1, the coupling block element being inserted between the half elements pushed into one another.

11. The Kenter shackle according to claim 10, wherein the housing of the coupling block element has protrusions or recesses on its side surfaces, which are to face the half elements, for positive locking guidance on complementary inner flanks of the half elements.

12. The Kenter shackle according to claim 10, wherein the protrusions of the locking elements are each spherically convex and the locking element receptacles are each spherically concave.

13. The Kenter shackle according to claim 10, wherein the limbs each have a raised surface on their inner flanks, wherein the surfaces on the opposite limbs are plane-parallel, and wherein the coupling block element is positively fixed between the half elements by its recesses and the edges of the surfaces and by the hemispherical protrusions of the locking elements, which engage in locking element receptacles on the inner surfaces of the half elements.

14. The Kenter shackle according to claim 10, wherein the locking element receptacles are divided in half and are formed in an edge region at a transition between the raised surface and the receiving chamber on the long limb or at the transition between the raised surface and the profile structure on the short limb.
